(19) United States
(12) Patent Application Publication
(10) Pub. No.: US 2024/0056174 A1
(43) Pub. Date: Feb. 15, 2024

(54) Radio Communications System called Eyestar

(71) Applicants: Hank D. Voss, Upland, IN (US); Jeff F. Dailey, Upland, IN (US); Matthew C. Voss, Upland, IN (US); Matthew B. Orvis, Upland, IN (US)

(72) Inventors: Hank D. Voss, Upland, IN (US); Jeff F. Dailey, Upland, IN (US); Matthew C. Voss, Upland, IN (US); Matthew B. Orvis, Upland, IN (US)

(21) Appl. No.: 18/233,530

(22) Filed: Aug. 14, 2023

Related U.S. Application Data
(60) Provisional application No. 63/397,867, filed on Aug. 14, 2022.

(51) Int. Cl. H04B 7/185; H04B 7/195; H04L 5/14

(52) U.S. Cl. CPC H04B 7/18515; H04B 7/195; H04L 5/14

(57) ABSTRACT

This is an Improved Radio Communications System called Eyestar. It is a simplex (one way, send or receive) or duplex (two-way, send and receive) Improved Radio Communications System called Eyestar. It provides a solution for quick, low power (0.2 W), reliable beaconing of data from one's satellite. The data is transmitted 24/7 anywhere and anytime with max data rates of 8 Bytes/sec operating continuously. The Simplex and Duplex versions has a Buffer to filter RF output from being damaged; it has a modified the internal firmware to improve broadcast speeds; it provides continuous connectivity for one's satellite in orbit (24/7); the simplex and duplex (they) have worked well in polar and lower inclinations and also for tumbling spacecraft; they need no ground station; they are FCC licensed; and they are less expensive, smaller, and require less power than the other qualified S-band, X-band radios.

### CROSS-REFERENCE TO RELATED APPLICATIONS

This application claims the benefit of U.S. Provisional Patent Application with Ser. No. 63/397,867 filed Aug. 14, 2022, by Hank Voss et al. The application is entitled “Improved Radio Communications System called Eyestar”.

### FIELD OF INVENTION

This invention relates to an Improved Radio Communications System called Eyestar. This invention is a simplex (one way) or duplex (two-way, send and receive) Improved Radio Communications System called Eyestar.

### FEDERALLY SPONSORED RESEARCH

None.

### SEQUENCE LISTING OR PROGRAM

None.

### BACKGROUND—FIELD OF INVENTION AND PRIOR ART

As far as known, there are no Improved Radio Communications System called Eyestar or the like with the improvements shown with this invention. It is believed that these simplex and duplex radio systems are unique in their design and technologies. They were developed for Low Earth Orbiting (LEO) satellites systems which are satellites that orbit approximately 160-2000 km above the surface of the earth. A type of system using these radio systems is a THINSAT HERITAGE FOR BLACK BOX—The Black Box technology which has evolved from the ThinSat production line which has embraced mass production and the miniaturization of electronics and mechanisms. ThinSats have proven to be ideal for STEM learning, research applications, and exploring the new region from 100 to 350 km for climate, ionospheric and DoD discovery THINSAT HERITAGE—The TSAT and GEARRS pioneered the CubeSat—NSL/Globalstar communication network for global and real-time (low latency) visibility of satellites with no required CubeSat ground stations. With mass production and the miniaturization of electronics and mechanisms very low cost and powerful ThinSats can be manufactured. These radio systems are ideal for the ThinSat satellites which are ideal for STEM learning, Research applications, and exploring the new region from 100 to 350 km for climate, ionospheric and DOD discovery with little worry for orbital debris problems because of short lifetimes (<1 month).

The introduction of the CubeSat has radically increased the accessibility of space. These use the Simplex and Duplex radios as well. CubeSats took advantage of cheap ride sharing opportunities to launch small, simple, high-risk missions with standardized designs. Their low cost allowed them to be developed by organizations with limited financial resources such as universities, schools and small businesses. This success has created new challenges as more universities are transitioning their efforts from educational programs towards research and new industries based around the commercial applications of CubeSats. As a result, the average CubeSat's have become more complex leading to higher costs and longer development times. Significant barriers to entry such as ground communication equipment (with associated knowledge of satellite communication and mission operations) and significant technical knowledge for space systems for integration and assembly still are issues for CubeSat developers.

### Problem Solved

The improvement and problem solved by the Improved Radio Communications System called Eyestar as satellite communication devices and radios employed are several. The Simplex and Duplex versions of the Eyestar has a Buffer to filter RF output from being damaged; they have modified the internal firmware to improve broadcast speeds; they have an improved change packet; they provide continuous connectivity for one's satellite in orbit (24/7); the simplex and duplex have worked well in polar and lower inclinations and for tumbling spacecraft; they need no ground station; they are FCC licensed; and they are less expensive, smaller, and require less power than the other qualified S-band, X-band radios.

### PRIOR ART

A novelty search revealed no other prior art that conflicts with this special eye frame leveling device. The prior art found included:
A. U.S. Pat. No. 11,206,079 issued in 2021 to Schloemert et al. and named Data transmission systems and methods using satellite-to-satellite radio links. Detailed is a radio communications system that uses 100 to 200 satellites in random low-earth orbits distributed over a predetermined range of north and south latitudes. The satellites themselves create a radio route between ground stations via radio links between multiple satellites by virtue of onboard global navigation satellite system circuitry for determining the location of the satellite and route creation circuitry for calculating in real time the direction from the satellite's location at a particular instant to a destination ground station. Directional antennas in the satellites transmit routing radio signals to enhance the probability of reception by other satellites. One embodiment facilitates the creation of satellite-to-satellite links by assigning each satellite a unique identifier, storing orbital information defining the locations of all the orbiting satellites in the system at any time, and including in the radio signal the unique identifier associated with the transmitting satellite.
B. U.S. Pat. No. 8,634,414 was issued in 2014 to Keng et al. and named Modular digital processing system for telecommunications satellite payloads. This is a telecommunications satellite payload processing system having one or more identical generic integrated processor modules is provided. The number of integrated processor modules can be selected in accordance with the antenna and bandwidth characteristics of a specified mission uplink and downlink in relation to the characteristics of the integrated processor module.
C. U.S. Pat. No. 9,612,334 issued to Gutt in 2017 and named Correcting for time delay variation in a satellite for positioning, navigation, or timing applications. Described here is a method for correcting for time delay variations between a plurality of signal paths from a signal source to at least one transmit antenna of a satellite may include measuring a time delay for each of the plurality of signal paths. The method may also include correcting a signal for the time delay variation based on the time delay for the signal path that is currently being used by the satellite, the corrected signal being usable for at least one of navigation, determining a geographic location and determining time.
D. U.S. Pat. No. 9,954,602B2 issued to Hoffmeyer et al. in 2018 and named Satellite communications data processing. Taught here is an apparatus comprising a backplane and several transponder slices connected to the backplane to form a transponder. The number of transponder slices comprise an analog front end configured to receive an analog input comprising a first plurality of bandwidths and a first plurality of interface frequencies, analog to digital converters configured to convert the analog input to digital signals, a digital channelizer configured to process the digital signals to generate a plurality of frequency slices, a digital combiner configured to assemble the plurality of frequency slices to form output sub-bands, a digital switch configured to route the plurality of frequency slices from the digital channelizer to the digital combiner, digital to analog converters configured to convert the output sub-bands to an analog output, and an analog back end configured to transmit the analog output comprising a second plurality of bandwidths and a second plurality of interface frequencies.
E. U.S. Pat. No. 9,391,726 issued to DeLuca in 2016 and named Wireless satellite digital audio radio service (SDARS) head unit with portable subscription and cell phone abilities. Shown is a system and method for automated activation of a radio, or content receiver, used to receive subscription radio services such as XM or Sirius radio. A wireless communications device with a short-range data link wirelessly communicates with the content receiver to control the content receiver and receive a unique identification code from the content receiver. The wireless communications device also has its own unique identification code. The wireless communications device transmits an activation request message over a long-range wireless communications link to a control station. The activation request message contains the receiver's unique identification code and the communications device's own unique identification code. The control station maintains a database of valid identification codes that is used to authenticate the request. If the control station receives a valid request, an activation signal is sent to the receiver to allow operation of the receiver.

As can be observed, none of the prior art has anticipated or caused one skilled in the art of radio systems for LEO type satellites and constellations devices and systems to see the concept and invention by Voss et al. The device provides an answer to a safe, efficient, and effective radio system for satellites used in experimentation and data collection in LEO and VLEO orbits.

### SUMMARY OF THE INVENTION

This invention is a simplex (one way) or duplex (two-way, send and receive) Improved Radio Communications System called Eyestar. EyeStar-S3: The EyeStar Simplex 30 is a solution for quick, low power (0.2 W), reliable beaconing from one's satellite. From research to health and safety data, the EyeStar Simplex delivers one's data 24/7 anywhere and anytime without a hitch. Max data rates are 8 Bytes/s but can operate all the time. EyeStar-D2: The EyeStar Duplex 31 gives one higher speed command and file data transfer up to 700 Byes/s over about 50% of earth coverage. It has flight heritage on 5 NSL FastBus satellites and two DOD satellites. To make connections the Duplex requires a stabilized satellite or low rotation.

The preferred embodiment of an Improved Radio Communications System called Eyestar is comprised of: an integrated computer processor with a buffer to filter and protect RF output and an improved change packet; a set of modified internal firmware for improved broadcast speeds; a 3.3V regulator; an STX 3+ Antenna; and a set of electronics with an internal measurement unit, temperature sensor, infrared (IR) sensor, and multiple analog/digital (A/D) input ports.

### OBJECTS AND ADVANTAGES

There are several objects and advantages of the Improved Radio Communications System called Eyestar. There are currently no known radio systems for small satellite cubes and space devices that are effective at providing the objects of this invention. The Improved Radio Communications System called Eyestar has various advantages and benefits:

| Item | Advantages |
|---|---|
| 1 | Has Buffer to filter RF output from being damaged |
| 2 | Has Modified the internal firmware to improve broadcast speeds |
| 3 | Has Change packet |
| 4 | Provides continuous connectivity for one's satellite in orbit (24/7) |
| 5 | Have worked well in polar and lower inclinations and |
| | for tumbling spacecraft |
| 6 | Needs no ground station |
| 7 | Is FCC licensed |
| 8 | Is less expensive, smaller, and require less power |
| | than the other qualified S-band, X-band radios |

Finally, other advantages and additional features of the present Improved Radio Communications System called Eyestar will be more apparent from the accompanying drawings and from the full description of the device. For one skilled in the art of radio and communications for small satellite systems, it is readily understood that the features shown in the examples with this product are readily adapted to other types of satellite communication systems and devices.

### DESCRIPTION OF THE DRAWINGS—FIGURES

The accompanying drawings, which are incorporated in and constitute a part of this specification, illustrate an embodiment of the Improved Radio Communications System called Eyestar that is preferred. The drawings together with the summary description given above and a detailed description given below explain the principles of the Eyestar device. It is understood, however, that the improved Eyestar communication invention is not limited to only the precise arrangements and instrumentalities shown.

FIGS. 1A through 1C are sketches of the general Improved Radio Communications System called Eyestar.

FIGS. 2A and 2B are typical NearSpace Launch (NSL) small cube satellites with the Improved Radio Communications System called Eyestar.

FIGS. 3A and 3B are additional sketches of the Improved Radio Communications System called Eyestar.

FIGS. 4A through 4D are more sketches and block diagrams of the Improved Radio Communications System called Eyestar.

FIGS. 5A through 4D are more sketches and block diagrams of the Improved Radio Communications System called Eyestar.

FIGS. 6A through 6F are the documentation and sketches for an EyeStar-S3 Simplex Communications Module Interface Control Document (ICD).

FIGS. 7A through 7F are the general communication systems and displays where the Eyestar is being used for satellite radio.

FIG. 8 is a Block Diagram of ThinSat system.

FIG. 9A through 9E are sketches of prior art.

### DESCRIPTION OF THE DRAWINGS—REFERENCE NUMERALS

The following list refers to the drawings:

TABLE B
Reference numbers

| Ref | |
|---|---|
| # | Description |
| 30 | Improved Radio Communications System called EyeStar Simplex |
| | 30 quick, low power (0.2 W), reliable beaconing from one's |
| | satellite |
| 31 | EyeStar-D2: The EyeStar Duplex 31 higher speed command and |
| | file data transfer up to 700 Byes/s over about 50% of earth |
| | coverage |
| 33 | Block flowchart 33 for Improved Radio Communications System |
| | 30 |
| 34 | radio communication flow chart 33 from the satellite to the client |
| 35 | layout view 35 of improved ThinSat 300 |
| 39 | Canisterized Satellite Dispenser (CSD) 39 dispenses multiple |
| | improved ThinSats 300 |
| 42 | IRIDIUM (duplex) or GlobalStar (simplex) communications |
| | network 42 which are satellite constellations to provide 24/7 |
| | global continuous data for a variety of mission purposes with |
| | the small satellites such as ThinSat or others |
| 43 | Radio Frequency (RF) modem 43 |
| 44 | Beacon Flight Module Controller Firmware 44 |
| 45 | watch dog 45 |
| 46 | serial data Input/Output 46 |
| 47 | Busy signal 47 |
| 48 | Analog Input/Output 48 |
| 50 | coax cable 50 |
| 51 | nadir sensor 51 |
| 52 | patch antenna assembly 52 for simplex or duplex |
| 53 | Power Regulator 53 |
| 54 | Ground Network tuning 54 (by professional by Near Space |
| | (NSL) Tuning |
| 55 | Redundant Fault Tolerant Server Network 55 |
| 56 | internet console display and plotting 56 |
| 57 | Options 57 such as Pins, IMU, Temperature, sensors, etc. |
| 61 | optional Micro-D connector 61 for the EyeStar D2 Duplex |
| | communication system 31 |
| 62 | RF Connection 62 |
| 63 | SD Card 63 |
| 64 | USB receiver port 64 |
| 65 | RF, Thermal and radiation shielding 65 |
| 70 | cube sat 70 - a ThinSat 300 system configured as a cube with |
| | surfaces for use as shown |
| 71 | 1.6 GHz Transmitter 71 with GlobalStar or Iridium patch |
| | antenna 52 |
| 72 | 2.4 GHz Receiver 72 with kill switch or Iridium patch |
| | antenna 52 |
| 73 | rail separation switches 73 |
| 74 | spring plungers 74 |
| 75 | 1-U FastBus structure 75 |
| 77 | solar panels 77 |
| 78 | Lithium Polymer (LiPo) battery pack 78, a small permanent |
| | magnet accompanied with Mu metal strips |
| 79 | PIN diode particle detector 79 |
| 81 | polymer science window 81 |
| 82 | NNU science payload hub 82 |
| 83 | CHS TI (Student) Launch pad 83 |
| 84 | NNU TI (university or academic organization) Launch pad 84 |
| 85 | CHS (Student) Radiation science board 85 |
| 87 | NNU (university or academic organization) Polymer science |
| | board 87 |
| 88 | polymer mass samples 88 shown on cantilevers |
| 300 | improved ThinSat unit 300 as part of the improved ThinSat |
| | constellations that are a group of satellites for carrying |
| | payloads for experimentation and data collection which are |
| | launched into and orbit through Low Earth Orbit (LEO) and |
| | Very Low Earth Orbit (VLEO) conditions |
| 340 | a chart 340 Simplex Coverage maps show good global coverage. |
| | Dots show packet transmission. |
| 350 | a chart 350 Black Box Particle Detector option demonstrating |
| | energetic particle data coverage map |
| 360 | GPS Beacon Packet Size Charts 360 |
| 370 | Specification Sheet 370 for EyeStar Simplex 30 and Duplex 31 |
| | radio communication systems |
| 390 | a simple communications architecture 390 |
| 390A | a graphic depiction 390A of Globalstar or Iridium constellation |
| | of satellites for Global coverage and real-time 24/7 visibility |
| 400 | a chart 400 demonstrating the overall Communications |
| | Architecture and Flow Diagram/Data transfer from many |
| | ThinSat EyeStar radios to the Internet, Console and |
| | Dashboard for the constellation Ground Segment |
| 410 | An example an illustration of a Web Console Telemetry |
| | Display 410 for a Simplex 30 |
| 500 | Prior Art 500 U.S. Pat. No. 11,206,079 by 2021 Schloemert |
| | et al. named Data transmission systems and methods using |
| | satellite-to-satellite radio links |
| 510 | Prior Art 510 U.S. Pat. No. 8,634,414 - 2014 by Keng |
| | et al. named Modular digital processing system for |
| | telecommunications satellite payloads |
| 520 | Prior Art 520 U.S. Pat. No. 9,612,334 - Gutt - 2017 named |
| | Correcting for time delay variation in a satellite for |
| | positioning, navigation, or timing applications |
| 530 | Prior Art 530 U.S. Pat. No. 9,954,602B2 by Hoffmeyer et al. in |
| | 2018 named Satellite communications data processing |
| 540 | Prior Art 540 U.S. Pat. No. 9,391,726 by DeLuca named Wireless |
| | satellite digital audio radio service (SDARS) head unit |
| | with portable subscription and cell phone abilities |

### DETAILED DESCRIPTION OF PREFERRED EMBODIMENT

This invention relates to an Improved Radio Communications System called Eyestar. This invention is a simplex (one way) or duplex (two-way, send and receive) Improved Radio Communications System called Eyestar.

The advantages for the Improved Radio Communications System called Eyestar 30 are listed above in the introduction. Succinctly the benefits are that the device:
A. Has Buffer to filter RF output from being damaged
B. Has Modified the internal firmware to improve broadcast speeds
C. Has Change packet
D. Provides continuous connectivity for one's satellite in orbit (24/7)
E. Have worked well in polar and lower inclinations and for tumbling spacecraft
F. Needs no ground station
G. Is FCC licensed
H. Is less expensive, smaller, and require less power than the other qualified S-band, X-band radios

The preferred embodiment of the Improved Radio Communications System called Eyestar 30 is comprised of: an integrated computer processor with a buffer to filter and protect RF output and an improved change packet; a set of modified internal firmware for improved broadcast speeds; a 3.3V regulator; an STX 3+ Antenna; and a set of electronics with an internal measurement unit, temperature sensor, infrared (IR) sensor, and multiple analog/digital (A/D) input ports.

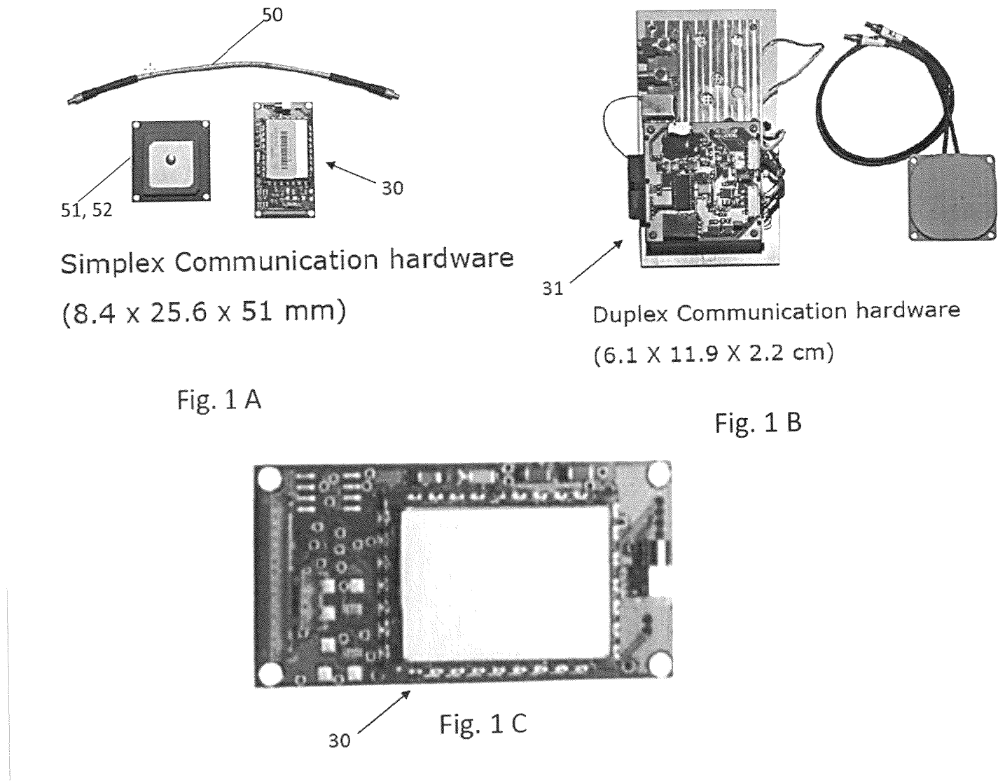

There is shown in FIGS. 1-9 a complete description and operative embodiment of the Improved Radio Communications System called Eyestar. In the drawings and illustrations, one notes well that the drawing FIGS. 1-9 demonstrate the general configuration and use of this product. The various example uses are in the operation and use section, below.

The accompanying drawings, which are incorporated in and constitute a part of this specification, illustrate an embodiment of the Improved Radio Communications System called Eyestar 30 that is preferred. The drawings together with the summary description given above and a detailed description given below explain the principles of the Eyestar 30. It is understood, however, that the Improved Radio Communications System called Eyestar 30 is not limited to only the precise arrangements and instrumentalities shown. Other examples of radio systems for satellites and the like as devices and uses are still understood by one skilled in the art of satellite and electronic communication systems and devices to be within the scope and spirit shown here.

FIGS. 1A through 1C are sketches of the general Improved Radio Communications System called Eyestar. Here are demonstrated the NearSpace Launch, Inc. EyeStar™ (NSL Eyestar) communication systems which offers a proven means of transmitting data from a small satellite the user/operator. The EyeStar™ radio systems work in conjunction with the Iridium and Globalstar satellite constellations to provide 24/7 global continuous data for a variety of mission purposes with the small satellites such as ThinSat or others. NSL has flown Simplex 30 and Duplex 31 units, with a high mission success rate. These radios are part of the NSL end-to-end communication system, which includes live coverage and near real time data results via the NSL data console. The NSL communication systems are designed to integrate into almost any project, and are available for individual commercial sale, for integration into NSL FastBus systems, and for integration into a Pumpkin™ CubeSat kit. Types of Eyestar include: Duplex 31 Communication hardware (6.1×11.9×2.2 cm), Simplex Improved Radio Communications System called EyeStar, and communication hardware (8.4×25.6×51 mm). Shown in these drawings are: an Improved Radio Communications System called EyeStar Simplex 30 quick, low power (0.2 W), reliable beaconing from one's satellite; an EyeStar-D2: the EyeStar Duplex 31 higher speed command and file a data transfer up to 700 Byes/s over about 50% of earth coverage; a coax cable 50; a nadir sensor 51; and a patch antenna assembly 52 for simplex or duplex.

NearSpace Launch data and ground station services provide a unique alternative to traditional ground station transmissions by providing 24/7 global ground connectivity. NSL provides this service by connecting to the Iridium and/or Globalstar ground station network and utilizing its 30 satellite constellations to bring data from a satellite to the internet stations in near real time. This enables quicker detection of problems, predictable transmission patterns, and more consistent data to observe trends, patterns, and location relative to the mission objectives of the satellite project. The NSL data system is also unique because it does not require a full ground station to collect or access data. One can simply go online to the internet, go to the NSL data console, and instantly access the satellite project data at any time of day. The NSL system does not require a traditional ground station and the ground station and data services are available to users at a monthly subscription charge that is a fraction of the cost of the radio data of the competition, while still providing 24/7, reliable data.

| | |
|---|---|
| Technical Specs: | Key product highlights: |
| A. Technical readiness (TRL: 9) | A. 100% Mission Success rate |
| B. 24/7 Coverage | B. Encompasses end to end |
| C. ARM processor and Firmware | transmission, system, no |
| Duplex: | need for a ground station |
| D. Duplex Rate: 50 Mb/day@ 50% | C. Low power, affordable |
| E. 700 Bytes/Second | data transfer |
| F. Must be spinning <¼ RPM | D. Fixed patch antenna |
| Simplex: | E. RF EMI certification |
| G. Simplex Rate: 600 Kb/day@ 70% | F. FCC compliant |
| H. 7 Bytes/Second | |
| I. Must be spinning <3 RPM | |

Options:
NSL provided FCC Licensing Assistance
NADIR Sensing
EyeStar D2 Duplex unit
Helical High Gain Antenna
EyeStar S3 Simplex unit
PC 104 standard form factor

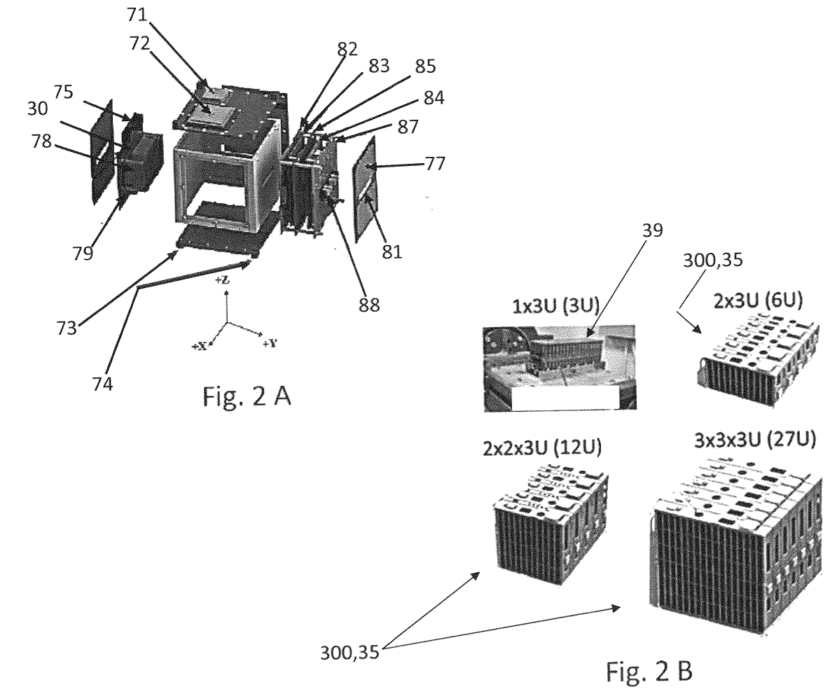

FIGS. 2A and 2B are typical NearSpace Launch (NSL) small cube satellites with the Improved Radio Communications System called EyeStar. Demonstrated here are: an Improved Radio Communications System called EyeStar Simplex 30 quick, low power (0.2 W), reliable beaconing from ones satellite; a layout view 35 of improved ThinSat 300; a canisterized Satellite Dispenser (CSD) 39 dispenses multiple improved ThinSats 300; a cube sat 70—a ThinSat 300 system configured as a cube with surfaces for use as shown; a 1.6 GHz Transmitter 71 with GlobalStar or Iridium patch antenna 52; a 2.4 GHz Receiver 72 with kill switch or Iridium patch antenna 52; a rail separation switches 73; a spring plungers 74; an 1-U FastBus structure 75; a solar panels 77; a Lithium Polymer (LiPo) battery pack 78, a small permanent magnet accompanied with Mu metal strips; [anticipated alternative batteries include: Nickle Cadmium batteries, Nickle Metal Hydride batteries, Lithium-Ion batteries, Small and sealed lead acid batteries which can be Absorbed glass mat (AGM) battery or gel battery (“gel cell”). Other experimental types include Lithium sulfur, Sodium-ion, Thin film lithium, Zinc-bromide, Zinc-cerium, Vanadium redox, Sodium-sulfur, Molten salt, and Silver-zinc]; a PIN diode particle detector 79; a polymer science window 81; a NNU science payload hub 82; a CHS TI (Student) Launch pad 83; a NNU TI (university or academic organization) Launch pad 84; a CHS (Student) Radiation science board 85; a NNU (university or academic organization) Polymer science board 87; a polymer mass samples 88 shown on cantilevers; and an improved ThinSat unit 300 as part of the improved ThinSat constellations that are a group of satellites for carrying payloads for experimentation and data collection which are launched into and orbit through Low Earth Orbit (LEO) and Very Low Earth Orbit (VLEO) conditions. NSL manufactures and produces Iridium and Globalstar enabled communication systems (EyeStar radios), ThinSats, CubeSats, and Black Boxes. NSL was founded following the successful mission of TSAT with Globalstar. The mission proved one could effectively connect 24/7 to an NSL EyeStar radio via the Iridium and Globalstar constellations. Iridium and GLOBALSTAR—operate low-earth-orbit (LEO) constellation of 40+ satellites and provide mobile satellite voice and data products and service packages. Customers around the world in industries such as government, emergency management, marine, and oil and gas rely on Globalstar satellites constellation to be smarter and faster. The EyeStar—The NSL/Globalstar and NSL/Iridium radios provide continuous connectivity for a user's satellite in orbit no matter where in space it is, and anytime (24/7 coverage). Real-time data at low latency of a few seconds is critical for mission success during regular, discovering satellite health problems early, making real-time data available for payload trigging, failure analysis, or monitoring attitude performance. The Simplex 30 radios work well in polar and lower inclinations and for tumbling spacecraft up to 12 rpm. Packet throughput is over 90%, over 100% of the earth. No ground station is necessary with the NSL radio since all secure data is available on the internet in near real-time from the Iridium and Globalstar commercial ground stations. Within the Thinsat is an Improved Radio Communications System called Eyestar. EyeStar-S3 is an End-to-End System, 24/7 connected to Iridium and Globalstar constellation, with latency of seconds Max 600 Kbytes/day, Anywhere-Anytime, 100% On-orbit success, Flight Ready, TRL 9, Compliant with new FCC requirements. The Figures show a 1U FastBus aluminum box structure from NSL (Near Space Launch Inc.) as shown in FIG. 2A. It is quite robust and passed two rounds of shock testing plus the actual launch. Five of its six sides are covered with solar panels containing two triple-junction GaAs solar cells each, separated by a center science window slot, through which the polymer test samples, radiation sensor, RBF pin, and diagnostic ports protrude, directly exposed to the external space environment. Most CubeSats like shown in the figures use ground station radio uplinks to send commands to the satellite and radio downlinks to send data from the satellite. Such grounds stations often operate in the VHF and UHF amateur bands. The design and operation of a ground station adds significant cost and complexity to CubeSat mission planning and operations. To avoid these issues, NSL utilizes an EyeStar simplex 30 radio, which communicates between the CubeSat and GlobalStar's LEO satellite constellation, using an SMS text messaging protocol. This “bent-pipe” communication method provides a 24/7 data downlink to several ground receiving gateways located around the globe, tied to a secure NSL data server, from which the NNU (university or academic organization) and CHS (Student) students can view near-real-time (2-minute latency) health and science data from MakerSat-0 on their smartphones and laptops anytime, anywhere. The low data rate of 3 Byte/s is adequate for MakerSat's small data volumes. As the first space VAR for Globalstar, NSL offers the only simplex communication systems authorized to interface with Globalstar's comprehensive international network for the small satellite/aerospace industry. This means that when one chooses EyeStar, he is leveraging satellites in the Iridium and Globalstar network—providing a high level of connectivity in LEO. The EyeStar Simplex 30 is a solution for quick, reliable beaconing from one's satellite. From research to health and safety data, EyeStar Simplex 30 delivers data without a hitch. The EyeStar Duplex 31 gives one control over a satellite. This communication responds to one's messages as well as transmitting the data back. To date, the Near Real-Time Data system of EyeStar Communication Systems has demonstrated incredibly fast data acquisition. TSAT beacons can be located just 11 seconds after turn-on.

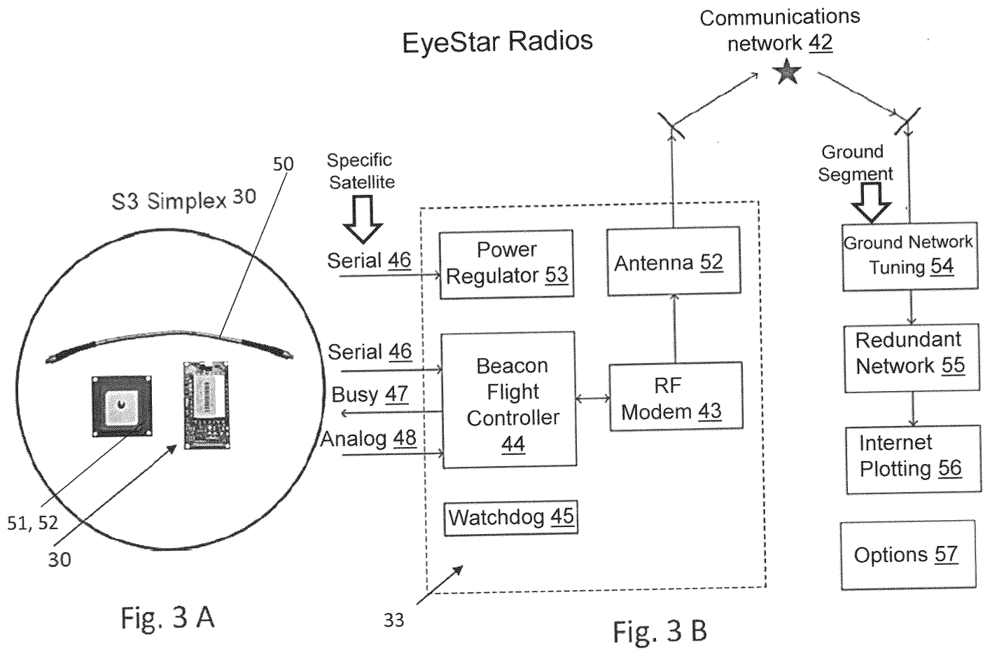

FIGS. 3A and 3B are additional sketches of the Improved Radio Communications System called EyeStar. Provided here are: an Improved Radio Communications System called EyeStar Simplex 30 quick, low power (0.2 W), reliable beaconing from ones satellite; a block flowchart 33 for Improved Radio Communications System 30; an IRIDIUM (duplex) or GlobalStar (simplex) communications network 42 which are satellite constellations to provide 24/7 global continuous data for a variety of mission purposes with the small satellites such as ThinSat or others; a Radio Frequency (RF) modem 43; a Beacon Flight Module Controller Firmware 44; a watch dog 45; a serial data Input/Output 46; a busy signal 47; an Analog Input/Output 48; a coax cable 50; a nadir sensor 51; a patch antenna assembly 52 for simplex or duplex; a Power Regulator 53; a Ground Network tuning 54 (by professional by Near Space (NSL) Tuning; a Redundant Fault Tolerant Server Network 55; an internet console display and plotting 56; and a set of options 57 such as Pins, IMU, Temperature, sensors, etc. Here is featured: End-to-end system; 600 Kbytes/day; Technical Readiness Level 9; FCC compliant; Connection in tumble; 100% on-orbit mission success; Ground station and console included; Low cost, size, and power; and turn on data in seconds. The EyeStar Simplex S3 30 also demonstrates:

Specifications

Dimensions: 15 × 26 × 55 mm
Weight: 22 g
I/O Interface: DF13, 14-pin
Comm Port: DF13, 4-Pin
Cooling: Thermal radiator shield
Enclosure: Open or Shielded
Input voltage range: 6-36 V
Aerospace Modem GlobalstarSTX-3
Tx: 1616.25 MHz downlink
Data input: 38.4 Kbps
Comm Port: Tx, Rx, Busy, GND
Effective throughput: 8 Bytes/s

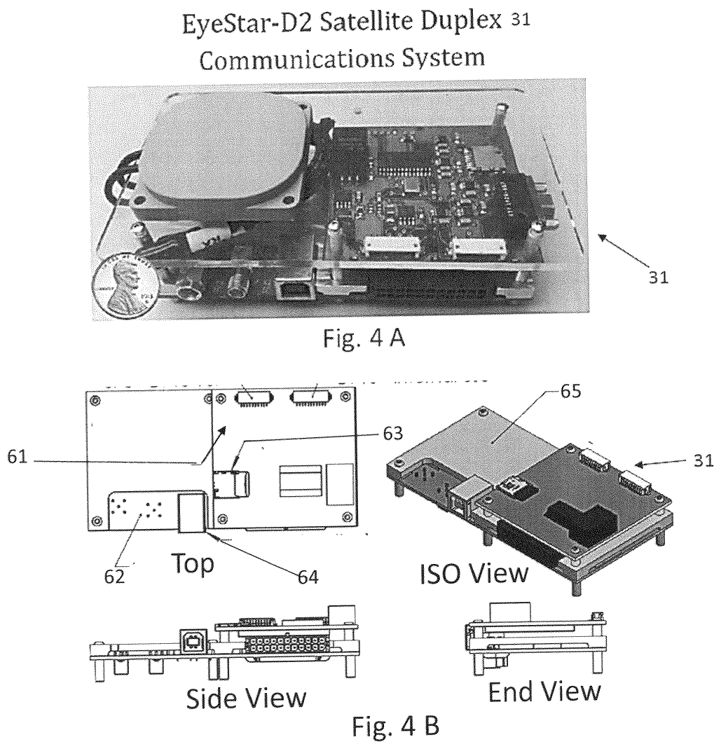

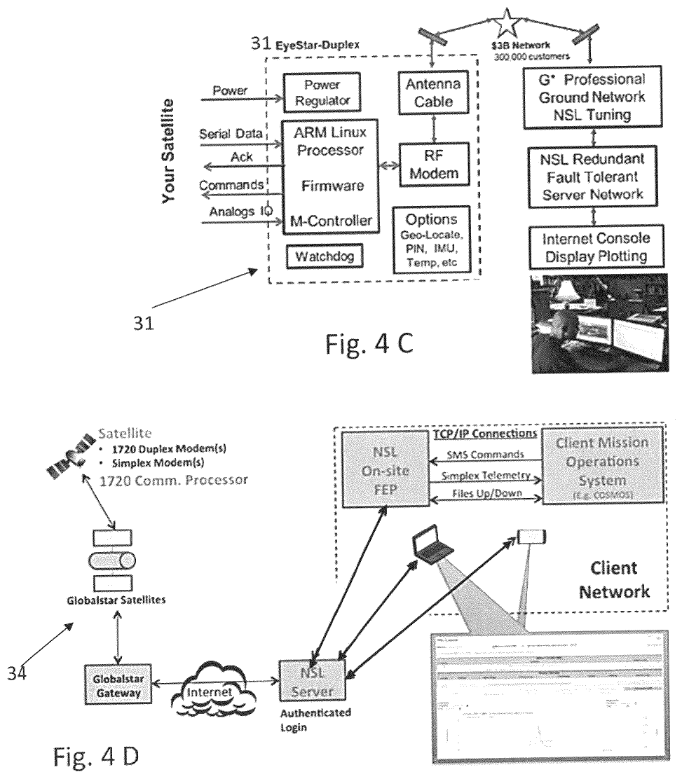

FIGS. 4A through 4D are more sketches and block diagrams of the Improved Radio Communications System called Eyestar. These drawings depict: an EyeStar-D2: The EyeStar Duplex 31 higher speed command and file a data transfer up to 700 Byes/s over about 50% of earth coverage; a radio communication flow chart 33 from the satellite to the client; an optional Micro-D connector 61 for the EyeStar D2 Duplex communication system 31; a RF Connection 62; a SD Card 63; an USB receiver port 64; and a RF, Thermal and radiation shielding 65. Demonstrated here are: the EyeStar-D2 Satellite Duplex Communications System 31. It is an End-to-End System, Iridium and/or Globalstar Connected, has Global Coverage, delivers at a Max 10 Mbytes/day*, is ARM, Flight Ready, and TRL 9, and is fully Compliant with new FCC requirements. See the following table for details.

Features
Flight Ready

Duplex units launched with 100% mission success
Technical Readiness Level 9
Orbit tested from 300 to 700 km
FCC & Iridium and/or Globalstar license compliant
Ground Segment Included
No Ground Station Required
Near Real-time data to one's server
Mission Console display software
Fully Operational Iridium and/or Globalstar & NSL
ground segment for data and display
Iridium and/or Globalstar Capacity for TT&C for 1000's of satellites
700 Bytes/sec, data transferred continuously at >25% connect time
Near Real-time data latency
ARM comm/flight processor
Iridium and/or Globalstar constellation ~30 satellites at 1414 km
Ideal for multi-Satellites (100 s).
Unified/Time-Ordered Small sat Database, a Critical Piece for Mission
Success
Specifications
Mechanical:
Dimensions: 6.1 × 11.9 × 2.2 cm
Weight: 138 g (0.30 lbs)
I/O Interface: DF13-12 pin
Antenna: SMA dual RX/TX
6 cm dia. mounting by 1 cm high
Cooling: Thermal radiator shield
Enclosure: Open or Shielded
Electrical:
Input voltage range: 6 to 20 V
Input voltage nominal: 7 V
Power-up current: 121 mA@ 7 V
Supply Power: 1.2 W RX, 2.2 W TX
RF:
GSP-1720 Aerospace Modem
Tx: 1610 to 1625 MHz downlink
Rx: 2484-2499 MHz uplink
Channel Access: CDMA Code Division
Radio Astronomy freq. exclusion
Active patch antenna (pts upward)
Max Tx power: +29 dBm (800 mW)
ERP: +34 dBm (~1 W)
Typical Power Transmit: 3.7 W
Link Margin: high, no atmosphere
Data I/O
Data input: 9600 bits/s full duplex
Effective data rates: 7000 bits/s
Handshaking and validated data
SMS Messaging: 35 characters input
ARM9 Processor 1 GHz
Clock Freq: 400 MHz
Debian Operating system
TCP-IP comm. protocols
8 GByte microSD
Custom programing available
Re-programmable in orbit
Data encryption available
Environmental/Flight Testing
Temperature: Passive heat sink/radiator
Antenna: −50 to +85 C.
Radio: −40 to +60 C.
Non-Operational: −60 to +100 C.
Vibration: Atlas Rocket/PPOD: 28 g; Orbital/Nanoracks: 20 g
Dose Radiation: Al and Ta spot shielding; 60 days in 350 by
700 km orbit; No upsets in SAMA
QA Radio Testing:
Vibration & Vacuum
Temperature testing
Multi-day burn-in
Final System Testing
Server/Radio Testing
Certification
In-Orbit Reliability
80+ Simplex units and 10+ Duplex units
launched, with 100% mission success
Customers
Various
Options
Engineering Model (EM): D2E
Flight Model (FM): D2F
No ARM processor, use desired processor
Duplex SMS Command Only: D2CE, D2CF (No ARM processor)
Geolocation Software Resolution 300 m to 100 km*
microD-9pin IO connector
Custom modification support
Helical High-Gain antenna recommended for ground testing
EyeStar-S3 Simplex now must be bundled with D2,
for pointing and spinning, at a reduced cost

EyeStar-D2 Satellite Duplex Communications System 31 has two (2)-way commanding, 10 MB/day, 25-50% Anywhere/Anytime data, ARM processor, Geolocation, and Handshaking. NSL Inc. is a certified Value-Added Reseller (VAR) of Iridium radios with Iridium and/or Globalstar Satellite radios as its heritage of approved FCC, EMI, Iridium, and Iridium and/or Globalstar EyeStar products. FIG. 4C shows PCB, EMI Shielding, Layout, EMI Test certification, Globalstar requirements, Firmware flight, ICD, Engineering Model (EM), Quality Assurance, Burn-in, Certification, Rad shielding, Flight Model (FM), FCC Compliant, Encryption, Compression, and NSL Support. FIG. 4D explains the satellite can have a communication radio system that is either Simplex—one way or Duplex—two-way between the ground crew and the satellite. Uplink can be with the Iridium or GlobalStar. Uplink/Downlink Over HTTPS; commands, Files, and more with the simple Simplex Telemetry and has optional AES Encryption for Sensitive Data

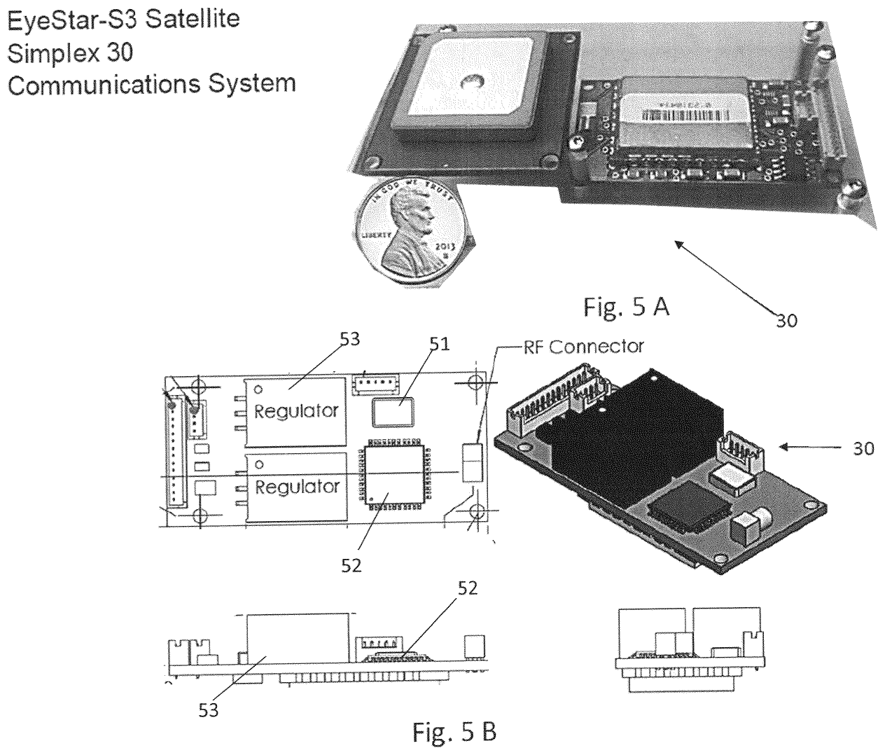

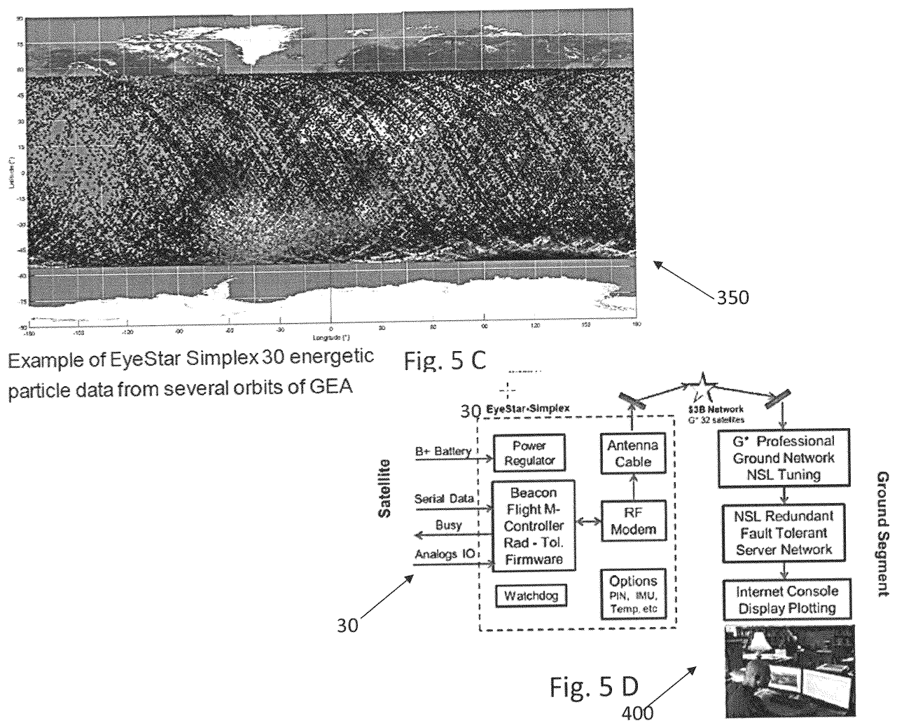

FIGS. 5A through 5D are more sketches and block diagrams of the Improved Radio Communications System called EyeStar. These drawing figures show: an Improved Radio Communications System called EyeStar Simplex 30 quick, low power (0.2 W), reliable beaconing from ones satellite; an EyeStar-D2: The EyeStar Duplex 31 higher speed command and file a data transfer up to 700 Byes/s over about 50% of earth coverage; a nadir sensor 51; a patch antenna assembly 52 for simplex or duplex; a Power Regulator 53; a chart 350 Black Box Particle Detector option demonstrating energetic particle data coverage map; and a chart 400 demonstrating the overall Communications Architecture and Flow Diagram/Data transfer from many ThinSat EyeStar radios to the Internet, Console and Dashboard for the constellation Ground Segment. Demonstrated here are: the EyeStar-D2 Satellite Simplex Communications System 30. EyeStar-S3 Satellite Simplex Communications System 30 again offers an End-to-End System, features an Iridium and/or Globalstar Connection, transfers data at a Max 600 Kbytes/day, is available Anywhere-Anytime, has 100% On-orbit success, and is Flight Ready, TRL 9, and Compliant with new FCC requirements.

Features
Flight Ready

Simplex units launched with 100% mission success
Technical Readiness Level 9
Orbit tested from 110 to 700 km
FCC & Iridium and/or Globalstar license compliant
Commercial & Research Link
Ideal for Beacon, GPS, summary data
Good link from tumbling satellite (<~3 rpm and 360-degree link)
Smart Zenith sensor to enforce FCC compliance
Good polar link, no dropouts
Microchip Flight micro-controller included, analog and digital
Ground Segment Included
No Ground Station Required
Near Real-time data to one's server
Console display software included
Fully Operational Iridium and/or Globalstar & NSL ground segment
for data &display
8 Bytes/sec, data transferred continuously,
About 95% data throughput
RF packets received a few seconds after first turn-on for con ops
Near Real-time data latency: ~1 s
Iridium and/or Iridium and/or ~30 satellites at 1414 km
Iridium and/or Globalstar Capacity for TT&C for 1000's of satellites
Ideal for Multi-Satellites: Unified/Time-Ordered Small Sat
Database
Critical Piece for Mission Success
Fits PocketQube Specifications
Specifications
Mechanical:
Dimensions: 15 × 26 × 55 mm
Weight: 22 g
I/O Interface: DF13, 14-Pin
Comm Port: DF13, 4-Pin
Antenna: SMA TX ceramic patch 25 mm side square by 7 mm high
Cooling: Thermal radiator shield
Enclosure: Open or Shielded
Electrical:
Input voltage range: 6-36 V
Idle Current @6 V: 29.7 mA (0.18 W)
Idle Current @15 V: 16.8 mA (0.25 W)
Tx Current @6 V: 264 mA (1.58 W)
Tx Current @15 V: 111 mA (1.66 W)
RF:
Aerospace Modem Globalstar STX-3 and/or Iridium equal
Tx: 1616.25 MHz downlink
BPSK Modulation
Radio Astronomy freq. exclusion
Passive patch antenna
Antenna Gain: 68 mW
ERP: 20 dBm
EIRP: 632 mW (−1.99 dBW)
Data I/O
Data input: 38.4 Kbps
Comm Port: Tx, Rx, Busy, GND
Effective throughput: 8 Bytes/s
TTL serial Interface
Microcontroller:
Ck Freq: 20 MHz
10 I/O Lines: User defined, configurable for analog,
digital, one wire, counter rate, or comm ports
Include Temp and Bus Voltage
Flight Beacon firmware
Custom firmware
Environmental/Flight Testing
Based on S2 and S3 Performance:
Temperature:
Passive heat sink/radiator
Antenna: −50 to +85 C.
Radio: −30 to +60 C.
Non-Operational: −60 to +100 C.
Vibration:
Delta: 30 g
Atlas Rocket/PPOD: 28 g
Orbital/Nanoracks: 20 g
SpaceX/Rocket Lab/PDOD: 20 g
Dose Radiation:
Spot Shielding
9 months in 350 by 700 km orbit
No dose problems or upsets in SAMA
QA Radio Testing:
Vibration, Vacuum, Thermal testing
Multi-day Burn-in
Final System Testing
Server/Radio Testing
Certification
In-Orbit Reliability:
100% mission success for all Simplex missions
Customers
Various
Options
Flight Model (FM): S3F
Engineering Model (EM): S3E
Power isolated unit
Custom modification support
Pumpkin/PC104 Standard form factor
Smaller form antenna
Integrated receiver PCB

Shown in FIG. 5C is an example of EyeStar Simplex 30 energetic particle data from several orbits of GEARRS2. Small gaps in the track show duty cycle of transmitter and long gaps due to sun sync of 78 packets of data sequence to save system power. Note the South Atlantic Magnetic Anomaly (SAMA) and the Aurora Oval. GEARRS simplex coverage maps are very uniform over the entire earth with a weaker coverage area in the Pacific Ocean. The 53-deg. latitude cutoff is due to the GEARRS2 Sat. inclination and not due to the Iridium and/or Globalstar link. FIG. 5D is a full operational block layout for an EyeStar-S3 Satellite Simplex Communications System 30. It again demonstrates PCB, EMI Shielding, Layout, EMI Test certification, Globalstar requirements, Firmware flight, ICD, Engineering Model (EM), Quality Assurance, Burn-in, Certification, Rad shielding, Flight Model (FM), FCC Compliant, Encryption, Compression, and NSL Support. FIG. 4D explains the satellite can have a communication radio system that is either Simplex—one way or Duplex—two-way between the ground crew and the satellite. Uplink can be with the Iridium or GlobalStar.

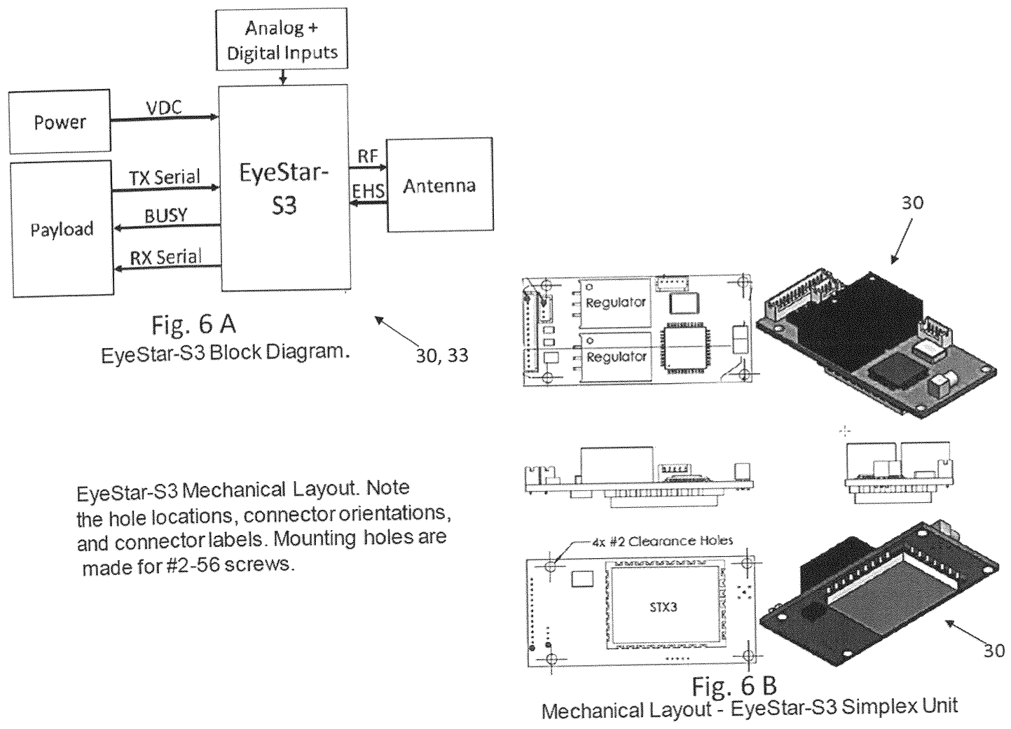

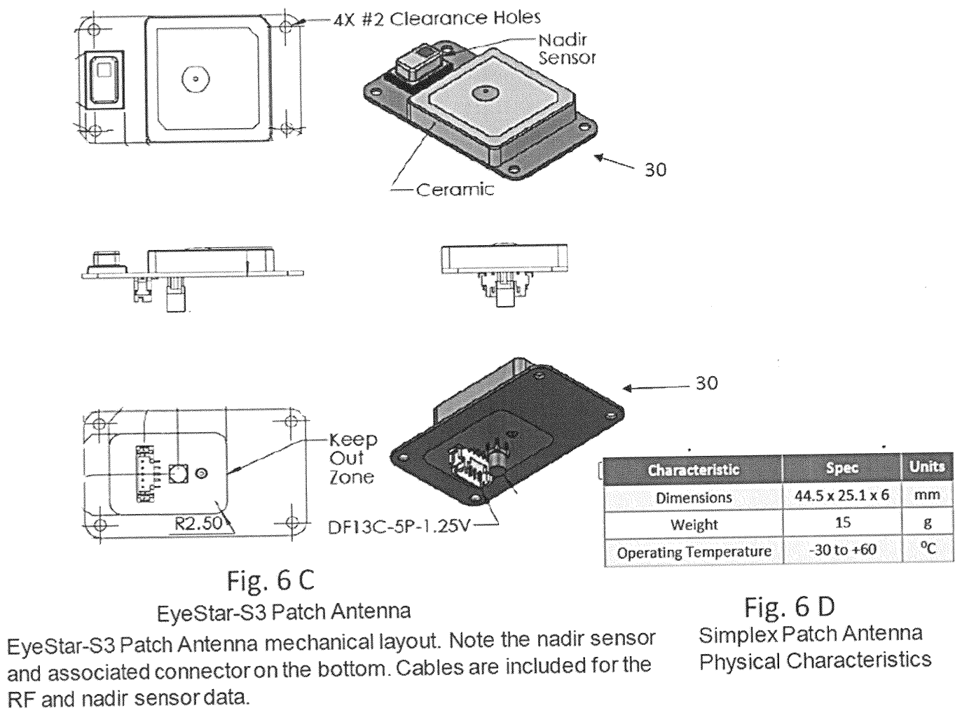

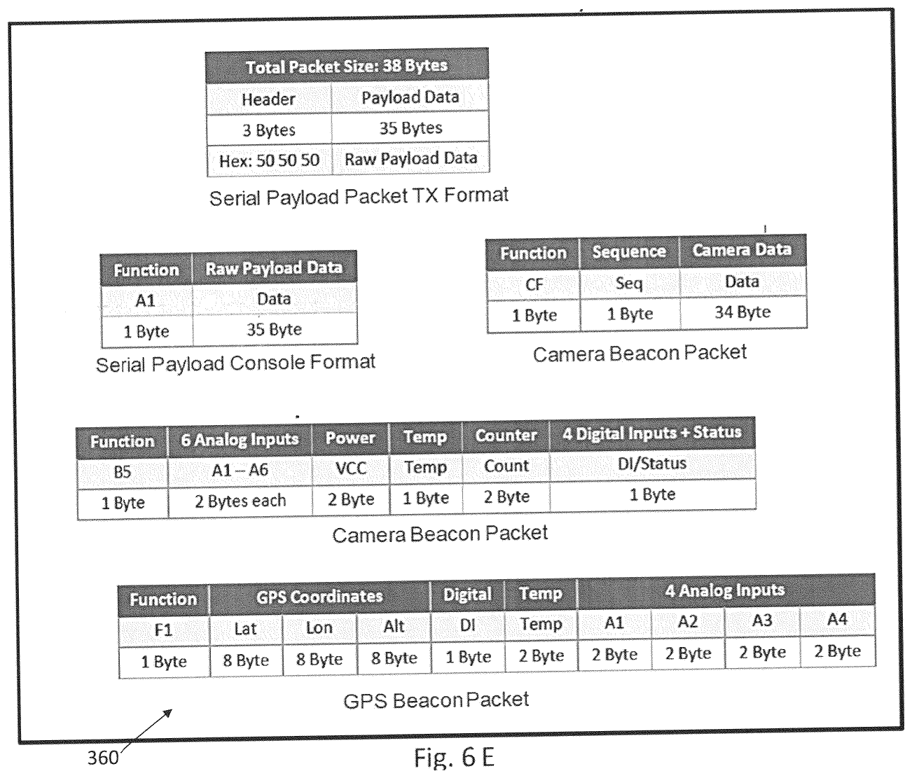

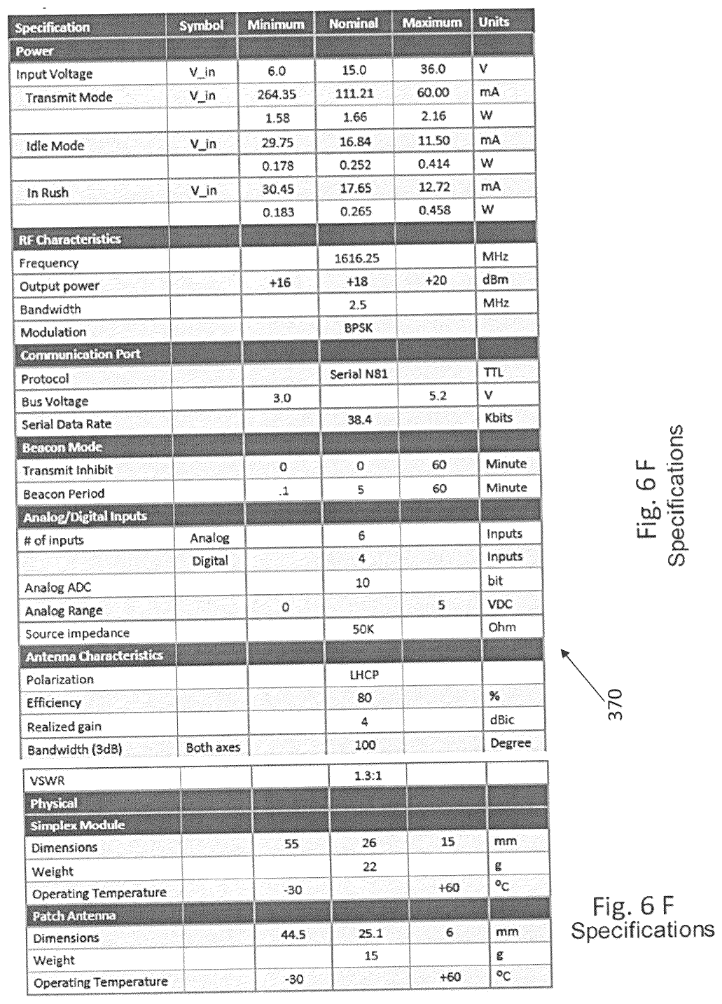

FIGS. 6A through 6F are the documentation and sketches for an EyeStar-S3 Simplex Communications 30 Module Interface Control Document (ICD). These drawing figures display an Improved Radio Communications System called EyeStar Simplex 30 quick, low power (0.2 W), reliable beaconing from one's satellite; a block flowchart 33 for Improved Radio Communications System 30; a GPS Beacon Packet Size Charts 360; and a Specification Sheet 370 for EyeStar Simplex 30 and Duplex 31 radio communication systems. This documentation describes the functional, physical, and electrical characteristics of the EyeStar-S3 satellite transmitter module. This interface control document is intended to provide the payload integrator with the necessary technical information to integrate the EyeStar-S3 Simplex 30 communications module. The Operational Description is: The EyeStar-S3 module is designed to send small packets of data from the user to the LEO Iridium and/or GlobalStar satellite network. The data is received by a ground station gateway, forwarded to the NearSpace Launch server, and delivered to the end user for processing. Two types of data packets are sent from the module: payload serial data and beacon data. Beacon data is a set of digital and analog inputs that are sent at a set interval for health and safety information. There are four digital and six analog inputs. Two parameters are setup for the user, transmit inhibit and beacon rate. Payload serial data is sent to the module through the serial port. Transmit rate for the serial data is set by the payload, while it is preconfigured for the beacon rate. Upon power up, the unit will wait for the user specified TX Inhibit Timer, then broadcast a user specified number of Wake-Up beacons. After this, the EyeStar-S3 will be functioning normally, beaconing at the set Beacon Rate, and available to be serially commanded between Beacons. A nadir sensor (earth horizon sensor, or EHS) is now included with the patch antenna to enforce zenith pointing transmission, in the case of a satellite without attitude control. This senses the earth pointing vector, and delays transmissions until the antenna is facing at the horizon or higher. This has been included to assist in meeting requirements from the FCC and Globalstar.

FIG. 6A is an EyeStar-S3 Block Diagram. FIG. 6B is a Mechanical Layout for the EyeStar-S3 Simplex Unit 30. Note the hole locations, connector orientations, and connector labels. Mounting holes are made for #2-56 screws. FIG. 6C is an EyeStar-S3 Patch Antenna mechanical layout. Note the nadir sensor and associated connector on the bottom. Cables are included for the RF and nadir sensor data. The Simplex patch antenna assembly, coax cable, and nadir sensor (EHS) cable are designed to integrate with the EyeStar module. The recommended cable length between the module and antenna is 6″, with a max allowable length of 24″. Antenna mounting holes are #2 Clearance holes. Note that the antenna requires a recessed surface for the cable connector. Include a keep out zone of at least 10 mm around the outside of the antenna assembly. FIG. 6D is the Simplex Patch Antenna Physical Characteristics.

FIG. 6E shows the Communication Protocol. There are two transmit modes, Beacon, and Serial. In Beacon mode, the EyeStar-S3 transmits set packet types with fixed formats at specified time intervals. This happens autonomously and requires no serial input or commanding to occur. In Serial mode, the EyeStar-S3 can be commanded to transmit any serial data that is sent to it, as long as the unit is available and not currently transmitting. If the EyeStar-S3 is beaconing, transmitting serial data, or unavailable, the BUSY line will be inserted. Otherwise, the BUSY line is not inserted, and the unit is available to transmit. Beacon Mode Example Packets—there are several example packets that could be transmitted in Beacon mode. Actual packets will vary slightly from these formats and should be clarified before flight. Health and Safety is the default, Beacon. Shown packets include a Health and Safety Beacon Packet, a GPS Beacon Packet, a Camera Beacon Packet, and a Serial Payload Communication Packet. Its format is that the payload sends data to the modem over the S3 Serial RX IN line when the BUSY signal is LOW. Once data is sent to the modem, the modem will return an ACK (from S3 Serial TX OUT) to acknowledge the packet. If the packet is good, the modem will set the BUSY line HI and send the data to the Iridium and/or Globalstar network. If the packet is not good, the BUSY line will not respond. Once finished sending, the BUSY line is set back to LOW, and the module waits to receive the next packet from the payload. Note that serial packets can be either 18 or 36 bytes (with 17 or 35 payload) bytes, depending on how the unit is configured. Consult NSL on recommended configurations, based on expected ADCS, usage, and orbit. For a Serial Payload Packet TX Format, the serial payload data is transmitted over the S3 Serial RX IN pin. A 3-byte header is first sent, followed by 35 (or 17) bytes of payload data. If this sequence is correctly sent the S3 will respond by setting the BUSY line HI. With the Serial Payload Console Format, once the data is received by Iridium and/or Globalstar it is sent to the NSL servers and displayed on the NSL Online Console. Serial Payload packets will be displayed with the function code ‘A1’ (or other), followed by the 35 (or 17) payload bytes. On the Serial Port, a half-duplex LVTTL/TTL a synchronous serial port (UART) is the primary interface to payload. The serial port operates with the serial parameters of 38,400 bps, 8 data bits, no parity, 1 stop bit. The TX, RX, and BUSY lines are 5V TTL. Finally, note that each data packet to the modem is sent in serial. Upon receiving the packet, the modem answers with an ACK if the packet is correct and transmits the packet. If the packet is incorrect, the BUSY line will not respond.

FIG. 6F shows the Specifications. The chart is self-explanatory.

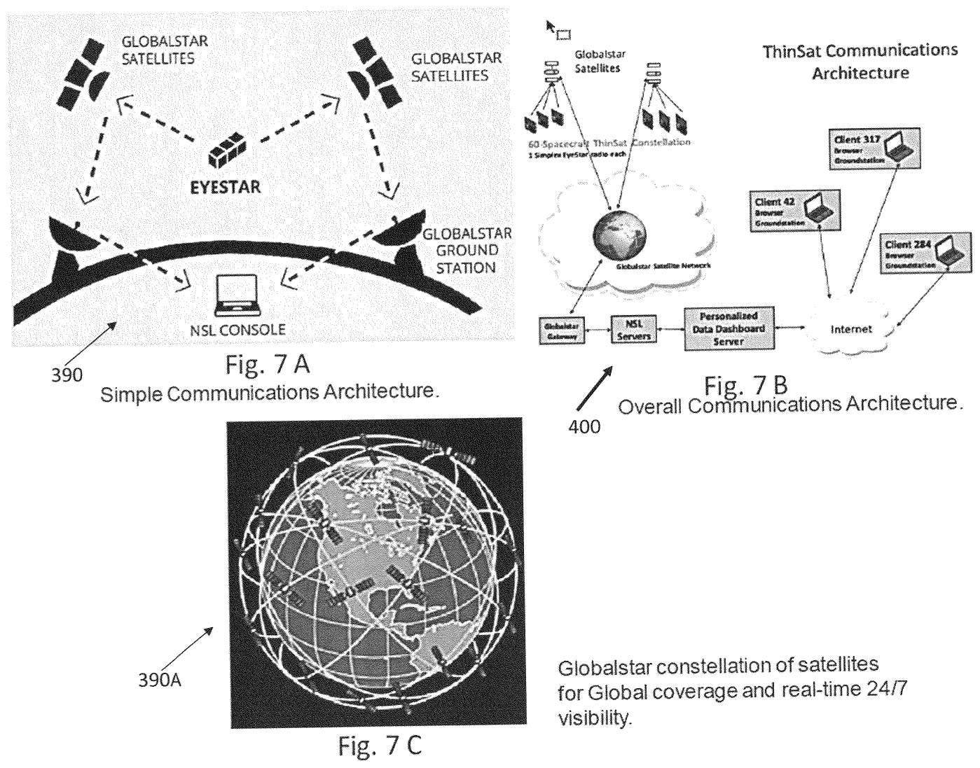

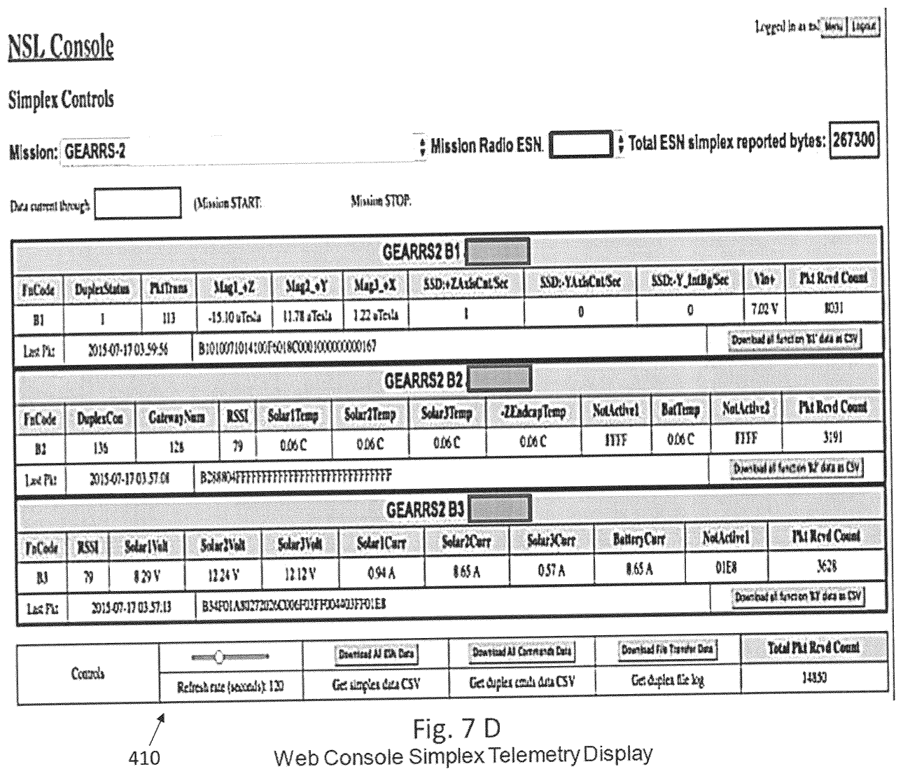

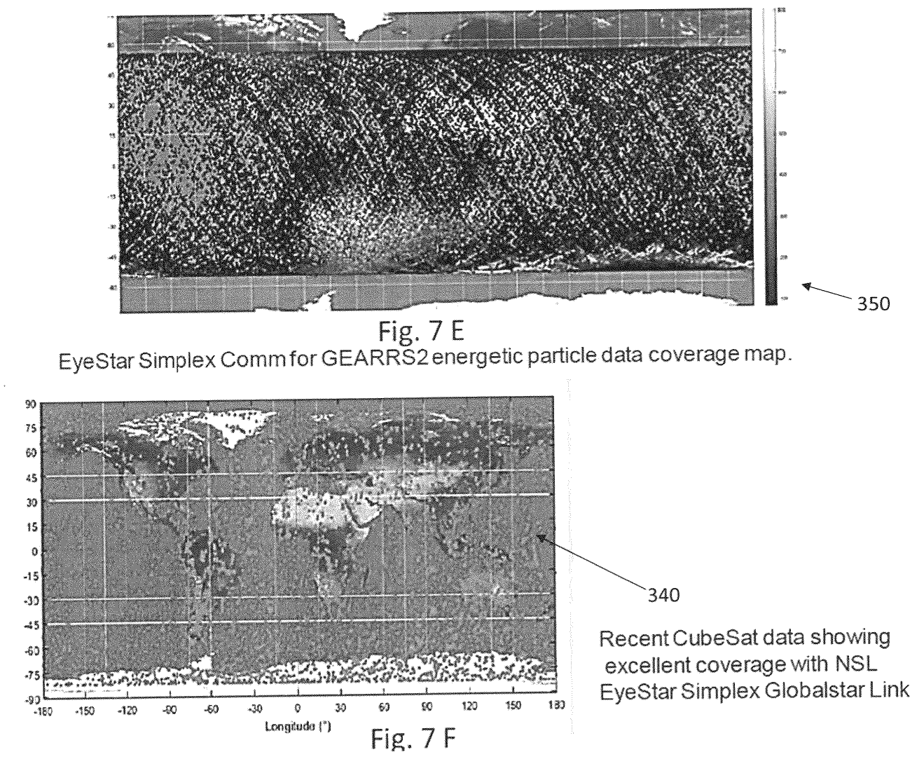

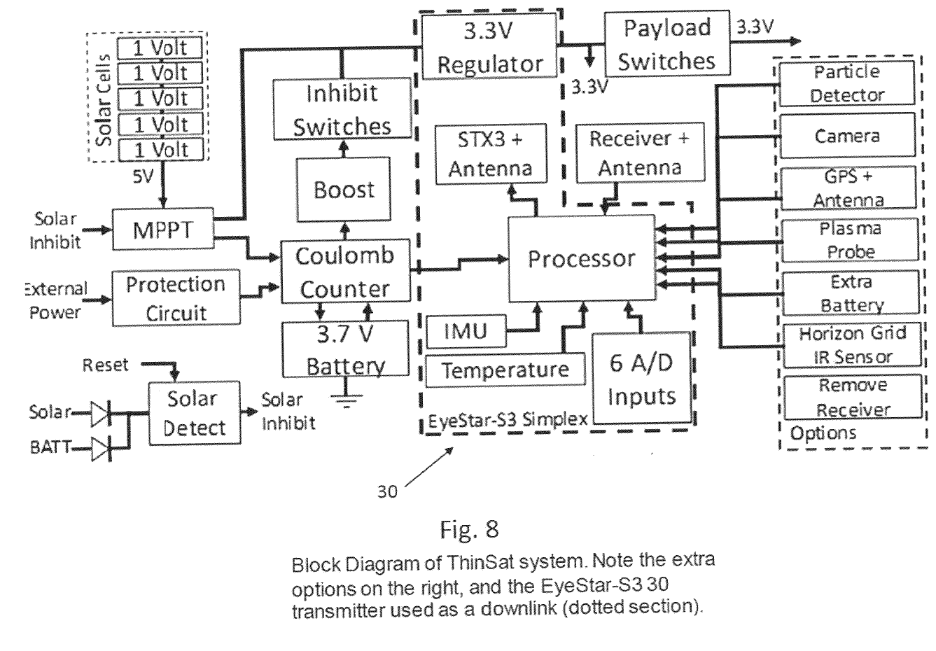

FIGS. 7A through 7F are the general communication systems and displays where the Eyestar is being used for satellite radio. FIG. 8 is a Block Diagram of ThinSat system. These are described in the Operation Section, below.

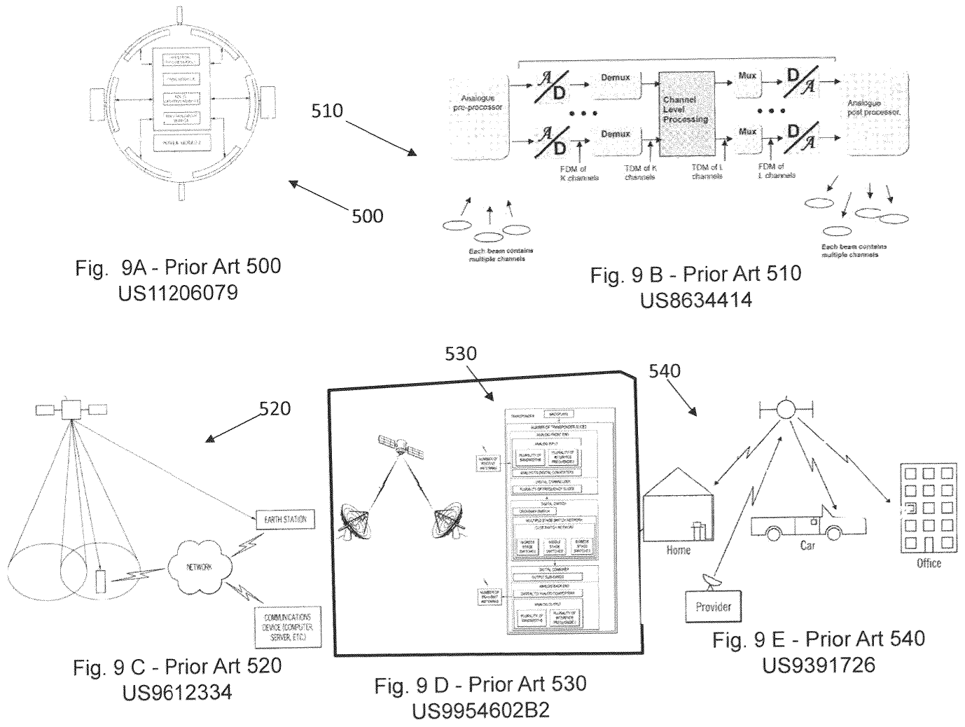

FIG. 9A through 9E are sketches of prior art. Here are former patents and applications for various satellite radio and communication systems. These include: Prior Art 500 U.S. Pat. No. 11,206,079 by 2021 Schloemert et al. named Data transmission systems and methods using satellite-to-satellite radio links; Prior Art 510 U.S. Pat. No. 8,634,414—2014 by Keng et al. named Modular digital processing system for telecommunications satellite payloads; Prior Art 520 U.S. Pat. No. 9,612,334—Gutt—2017 named Correcting for time delay variation in a satellite for positioning, navigation, or timing applications; Prior Art 530 U.S. Pat. No. 9,954,602B2 by Hoffmeyer et al. in 2018 named Satellite communications data processing; and Prior Art 540 U.S. Pat. No. 9,391,726 by DeLuca named Wireless satellite digital audio radio service (SDARS) head unit with portable subscription and cell phone abilities. As can be seen, the Improved Radio Communications System called Eyestar is a unique combination and use as described herein.

The details mentioned here are exemplary and not limiting. Other specific components and manners specific to describing an Improved Radio Communications System called Eyestar device 30 may be added as a person having ordinary skill in the field of the art of satellite radios, communication, and operations.

### OPERATION OF THE PREFERRED EMBODIMENT

The Improved Radio Communications System called Eyestar 30 has been described in the above embodiment. The manner of how the device operates is described below. One notes well that the description above and the operation described here must be taken together to fully illustrate the concept of the Improved Radio Communications System called Eyestar device 30. The preferred embodiment of the Improved Radio Communications System called EyeStar is comprised of: an integrated computer processor with a buffer to filter and protect RF output and an improved change packet; a set of modified internal firmware for improved broadcast speeds; a 3.3V regulator; an STX 3+ Antenna; and a set of electronics with an internal measurement unit, temperature sensor, infrared (IR) sensor, and multiple analog/digital (A/D) input ports.

The Operational Description is: The EyeStar-S3 module is designed to send small packets of data from the user to the LEO Iridium and/or GlobalStar satellite network. The data is received by a ground station gateway, forwarded to the NearSpace Launch server, and delivered to the end user for processing. Two types of data packets are sent from the module: payload serial data and beacon data. Beacon data is a set of digital and analog inputs that are sent at a set interval for health and safety information. There are four digital and six analog inputs. Two parameters are setup for the user, transmit inhibit and beacon rate. Payload serial data is sent to the module through the serial port. Transmit rate for the serial data is set by the payload, while it is preconfigured for the beacon rate. Upon power up, the unit will wait for the user specified TX Inhibit Timer, then broadcast a user specified number of Wake-Up beacons. After this, the EyeStar-S3 will be functioning normally, beaconing at the set Beacon Rate, and available to be serially commanded between Beacons. A nadir sensor (earth horizon sensor, or EHS) is now included with the patch antenna to enforce zenith pointing transmission, in the case of a satellite without attitude control. This senses the earth pointing vector, and delays transmissions until the antenna is facing at the horizon or higher. This has been included to assist in meeting requirements from the FCC and Globalstar.

FIGS. 7A through 7F are the general communication systems and displays where the Eyestar is being used for the radio of the satellite. In these drawings are depicted: a chart 340 Simplex Coverage maps show good global coverage. Dots show packet transmission; a chart 350 Black Box Particle Detector option demonstrating energetic particle data coverage map; a simple communications architecture 390; a graphic depiction 390A of Globalstar or Iridium constellation of satellites for Global coverage and real-time 24/7 visibility; a chart 400 demonstrating the overall Communications Architecture and Flow Diagram/Data transfer from many ThinSat EyeStar radios to the Internet, Console and Dashboard for the constellation Ground Segment; and an example an illustration of a Web Console Telemetry Display 410 for a Simplex 30. Note in these sketches, the Iridium and/or Globalstar constellation is shown. With its few seconds latency, the Iridium and/or Globalstar network can enable a high degree of autonomy within satellite operations due to near real-time knowledge of satellite conditions. This can significantly reduce the risk of orbit operations with adaptability and optimization, and at much lower cost. FIG. 7A is Simple Communications Architecture. Iridium and/or Globalstar Data Capacity—Iridium and/or Globalstar has sufficient current network and system capacity. Even if there were hundreds of CubeSats in orbit, all simultaneously using the Globalstar network, the communications load would be just a tiny fraction of the traffic that Globalstar currently handles. There are currently no capacity issues at any individual gateway, nor are there anticipated to be any future capacity limitations due to the addition of CubeSats. The Iridium and/or Globalstar system appear to have the capacity to handle thousands of CubeSats transmitting thousands of packets per day. FIG. 7B is Overall Communications Architecture. This is the Data Operations—Here the NSL ground station technology is comprised of the following elements: The Globalstar communications network; The NSL server; The Web Console; The web Application Program Interface (API); and The Front-End Processor (FEP). The Iridium and/or Globalstar communications network provides the actual ground-to-space link. All the normal radio link management issues are delegated to Iridium and/or Globalstar. The NSL server communicates via the Iridium and/or Globalstar network to send and receive satellite data. All data is logged and archived on the server. The server database performs real-time replication to a backup server. The typical full path latency for Simplex 30 data from satellite to the NSL server is under 5 seconds. FIG. 7C is Iridium and/or Globalstar constellation of satellites for Global coverage and real-time 24/7 visibility. FIG. 7D is a Web Console Simplex Telemetry Display. For those who desire, the NSL web console (FIG. 7D) permits viewing, graphing, zooming, translation, and downloading Simplex telemetry data (commonly 18 or 36 Bytes per packet). To display and download meaningful Simplex telemetry data fields, the web console code performs packet de-commutation and reverse quantization on the raw bytes to convert the Simplex field values back to the original engineering unit values. The first byte of each Simplex packet identifies the packet type and dictates how the rest of the packet is to be processed, in a secure manner, leveraging best industry practices. The web console also handles interactive uploading and downloading of files via the Duplex file transfer link, as well as sending short commands (1-35 bytes) via the SMS channel. Real-time tracking of balloon flight locations and real-time satellite position plotting on maps are also available using the web console.

The Globalstar Simplex link beacon for the Black Box has performed well on 100 commercial EyeStar communication systems since 2014 with 100% reliability (all mission success) with an associated ground segment. The low-power EyeStar Simplex communication systems have been tested between 750 km in altitude to reentry at 110 km and have a TRL=9. Over 60 satellites with EyeStar Simplex units are manifested for 2020. Other advantages of the EyeStar Simplex radios and the Black Box include: no new ground station required, simple fixed 25 mm square patch antenna, operates through high degree tumble rates, and a typical data latency of several seconds from satellite to user. In FIG. 7E is an EyeStar Simplex Comm for GEARRS2 energetic particle data coverage map. This is an example of STX-2 Simplex energetic particle data from several orbits of GEARRS2. Small gaps in the track show duty cycle of transmitter and long gaps due to sun sync of 78 packets of data sequence to save system power. Note the South Atlantic Magnetic Anomaly (SAMA) and the Aurora Oval. GEARRS2 Simplex coverage maps (FIG. 7E) are uniform over the entire earth with a weaker coverage area in the Pacific Ocean. The 53-deg. latitude cutoff is due to the GEARRS2 Satellite inclination and not due to the Iridium and/or Globalstar link. FIG. 7F is a Recent CubeSat data showing excellent coverage with NSL EyeStar Simplex Iridium and/or Globalstar Link over the polar region (Globalstar Satellites at 51deg Inclination and 1400 km altitude).

FIG. 8 is a Block Diagram of ThinSat system. Note the extra options on the right, and the EyeStar-S3 transmitter used as a downlink (dotted section). Shown is an Improved Radio Communications System called EyeStar Simplex 30 quick, low power (0.2 W), reliable beaconing from one's satellite. Each ThinSat launched includes a thin patch PCB, 2.2 Ahr Battery, EPS, processor, GPS, antennas, Simplex radio 30, solar cells, sensors, and AL7075 frames.

With this description it is to be understood that the Improved Radio Communications System called Eyestar 30 is not to be limited to only the disclosed embodiment of product. The features of the Eyestar 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. Various features and aspects of the disclosed embodiments can be combined with or substituted for one another to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed considering the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it be c understood that only selected embodiments have been shown and described and that all changes, modifications and equivalents that come within the spirit of the disclosures described heretofore and or/defined by the following claims are desired to be protected.

What is claimed is:

1. An Improved Radio Communications System for broadcast of data called EyeStar for use with a Low Earth Orbiting (LEO) satellite, the improved radio communication system comprising:
(a) an integrated computer data processor;
(b) a set of modified internal firmware;
(c) a regulator;
(d) a patch antenna;
(e) a set of electronics; and
(f) a battery packs for power
wherein the Radio Communications System provides continuous 24/7 connectivity to a communications network (G or I) for the LEO satellite while in orbit, works well in polar and lower inclinations and for tumbling spacecraft; needs no ground station, is FCC licensed, and is relatively less expensive, smaller, and require less power than the other qualified S-band and X-band radios.

2. The Radio Communications System described in claim 1 wherein the type of broadcast of data is selected from the group consisting Simplex—one way data broadcast and Duplex—two way data broadcast.

3. The Radio Communications System described in claim 1 wherein the integrated computer data processor is configured with a buffer to filter and to protect a Radio Frequency (RF) output.

4. The Radio Communications System described in claim 1 wherein the set of modified internal firmware is configured for improved data broadcast speeds.

5. The Radio Communications System described in claim 1 wherein the regulator is a 3.3 Volt regulator.

6. The Radio Communications System described in claim 1 wherein the patch antenna is an Aerospace Modem GlobalstarSTX-3.

7. The Radio Communications System described in claim 1 wherein the set of electronics is selected from the group consisting of an internal measurement unit, a temperature sensor, an infrared (IR) sensor, and a set of multiple analog/digital (A/D) input ports.

8. The Radio Communications System described in claim 1 wherein the battery packs for power is a Lithium Polymer (LiPo) battery pack.

9. The Radio Communications System described in claim 1 wherein the battery packs for power is selected from the list consisting of Nickle Cadmium batteries, Nickle Metal Hydride batteries, Lithium-Ion batteries, sealed lead acid batteries; Absorbed glass mat (AGM) batteries; gel batteries; Lithium sulfur batteries; Sodium-ion batteries; Thin film lithium batteries; Zinc-bromide batteries; Zinc-cerium batteries; Vanadium redox batteries; Sodium-sulfur batteries; Molten salt batteries; and Silver-zinc batteries.

10. The Radio Communications System described in claim 1 wherein the continuous 24/7 connectivity to a communications network is selected from the group consisting of a GlobalStar system and an Iridium system.

11. An Improved Radio Communications System for broadcast of data called EyeStar for use with a Low Earth Orbiting (LEO) satellite, the improved radio communication system comprising:
(a) an integrated computer data processor configured with a buffer to filter and to protect a RF output;
(b) a set of modified internal firmware configured for improved data broadcast speeds;
(c) a 3.3 V regulator;
(d) an Aerospace Modem Globalstar STX-3+ patch antenna;
(e) a set of electronics configured with an internal measurement unit, a temperature sensor, an infrared (IR) sensor, and a set of multiple analog/digital (A/D) input ports; and
(f) a Lithium Polymer (LiPo) battery powerpacks for power
wherein the Radio Communications System provides continuous 24/7 connectivity to a communications network for the LEO satellite while in orbit, works well in polar and lower inclinations and for tumbling spacecraft; needs no ground station, is FCC licensed, and is relatively less expensive, smaller, and require less power than the other qualified S-band and X-band radios.

12. The Radio Communications System described in claim 11 wherein the broadcast for data is Simplex—one way data broadcast.

13. The Radio Communications System described in claim 12 wherein the continuous 24/7 connectivity to a communications network is a GlobalStar system.

14. The Radio Communications System described in claim 11 wherein the broadcast for data is Duplex—two-way data broadcast.

15. The Radio Communications System described in claim 14 wherein the continuous 24/7 connectivity to a communications network is an Iridium system.
